(19) United States
(12) Patent Application Publication
(10) Pub. No.: US 2005/0082002 A1
(43) Pub. Date: Apr. 21, 2005

(54) Method of cleaning a film-forming apparatus and film-forming apparatus

(76) Inventors: Yuusuke Sato, Tokyo (JP); Naoki Tamaoki, Tokyo (JP); Satoko Seta, Inagi-shi (JP); Regis Zils, Thionville (FR); Jun Sonobe, Tsukuba-shi (JP); Takako Kimura, Tsukuba-shi (JP); Kayo Momoda, Tsukuba-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/927,097

(22) Filed: Aug. 27, 2004

(30) Foreign Application Priority Data
Aug. 29, 2003 (JP) 2003-209691

(51) Int. Cl. B08B 9/00; C23F 1/00

(52) U.S. Cl. 156/345.29; 134/22.1; 216/58

(57) ABSTRACT

A method of cleaning a film-forming apparatus to remove at least a part of a silicon-based material deposited on a constituent member of the film-forming apparatus after used to form thin films includes introducing a first-gas including fluorine gas and a second gas including nitrogen monoxide gas into the film-forming apparatus, and heating the constituent member. The constituent member includes quartz or silicon carbide, and the silicon-based material includes silicon nitride.

### CROSS-REFERENCE TO RELATED APPLICATIONS

This application is based upon and claims the benefit of priority from prior Japanese Patent Application No. 2003-209691, filed Aug. 29, 2003, the entire contents of which are incorporated herein by reference.

### BACKGROUND OF THE INVENTION

1. Field of the Invention

The present invention relates to a method of cleaning a film-forming apparatus and a film-forming apparatus equipped with a cleaning system.

2. Description of the Related Art

In manufacturing a semiconductor device, various (insulating) thin films such as a silicon dioxide film or a silicon nitride film are formed by using a film-forming apparatus comprising a chemical vapor deposition reaction chamber (CVD reaction chamber). In forming the thin film, the CVD reaction product is deposited not only on the surface of a target semiconductor wafer but also on the constituent member of the film-forming apparatus such as the wall of the CVD reaction chamber, the boat for supporting the semiconductor wafer or the susceptor. The deposited CVD reaction product on the constituent members, if left unremoved, peels off from, for example, the inner wall of the CVD reaction chamber. This generates particles and results in degrading the semiconductor thin film formed on the wafer by the CVD reaction in the subsequent step. Thus, it is necessary to clean the film-forming apparatus.

With a low pressure (LP) CVD apparatus, for example, the cleaning is usually performed by opening the apparatus to the air, and washing the apparatus with an acidic solution. In this case, however, the operation of the film-forming apparatus must be once stopped, and then the apparatus is dismantled, washed, assembled and checked for the leakage. Apparently, a long down time is required resulting in decreasing productivity.

An LPCVD apparatus that permits performing the cleaning by using a reactive plasma without opening the film-forming apparatus to the air is available on the market. In this case, a gas like NF₃ or CF₄ is used as the reactive gas. Further, a cleaning method using FNO or F₃NO gas, in the aspect of specific fleon reduction, to create a plasma to remove silicon-containing compounds deposited on the stainless steel, aluminum or the aluminum alloy is disclosed (see WO 02/257131). However, for plasma cleaning, a costly plasma apparatus should be provided only for the cleaning purpose, although the plasma is not used in the CVD process. It should also be noted that because the active chemical species activated by the plasma are highly corrosive and short-lived, a special treatment is often required for the inner wall of the apparatus.

Further, it has been proposed in respect of the LPCVD apparatus to perform the cleaning within the CVD reaction chamber by a thermal reaction by using a reactive gas. In this case, a fluorine-containing gas such as ClF₃, NF₃, HF or fluorine gas is used singly or in combination as the reactive gas. With this cleaning method, the CVD chamber generally made of quartz is damaged by these reactive gases. It should also be mentioned that especially in the cleaning of silicon nitride, life time of the CVD reaction chamber becomes remarkably shortened and high maintenance fee is required, because the cleaning rate of the cleaning object (silicon nitride) is almost the same as that of the quartz.

In order to overcome the above-noted problems, a technique is disclosed in Japanese Patent Disclosure (Kokai) No. 2000-77391, in which a mixture of nitrogen monoxide gas and ClF₃ gas is used to remove the silicon nitride by thermal reaction. However, the ClF₃ is a costly gas, increasing the cleaning cost.

### BRIEF SUMMARY OF THE INVENTION

Accordingly, an object of the present invention is to provide a method of cleaning a film-forming apparatus, which permits removing a silicon-based deposit while suppressing the damage done to a constituent member of the film-forming apparatus, and to provide a film-forming apparatus.

According to an aspect of the present invention, there is provided a method of cleaning a film-forming apparatus to remove at least a part of a silicon-based material deposited on a constituent member of the film-forming apparatus after used to form thin films, comprising introducing a first gas comprising fluorine gas and a second gas comprising nitrogen monoxide gas into the film-forming apparatus; and heating the constituent member, wherein the constituent member comprises quartz or silicon carbide, and the silicon-based material comprises silicon nitride.

According to another aspect of the present invention, there is provided a film-forming apparatus including a reaction chamber configured to form a silicon nitride film on a wafer therein, the apparatus comprising a first gas introducing system configured to introduce a first gas comprising fluorine gas into the reaction chamber, and a second gas introducing system configured to introduce a second gas comprising nitrogen monoxide gas into the reaction chamber.

### BRIEF DESCRIPTION OF THE SEVERAL VIEWS OF THE DRAWING

FIG. 1 is a block diagram illustrating a film-forming apparatus equipped with a cleaning system according to an embodiment of the invention;

FIG. 2 is a block diagram illustrating a film-forming apparatus equipped with a cleaning system according to another embodiment of the invention;

FIG. 3 is a block diagram illustrating a film-forming apparatus equipped with a cleaning system according to still another embodiment of the invention;

FIG. 4 is a graph showing etching selectivity of silicon nitride to quartz relative to a cleaning temperature;

FIG. 5 is a graph showing etching rate and selectivity of silicon nitride and quartz relative to the flow ratio of nitrogen monoxide gas flow rate and fluorine gas flow rate;

FIG. 6 is a graph showing etching rates of silicon nitride and quartz relative to the flow ratio of nitrogen monoxide gas flow rate and fluorine gas flow rate; and

FIG. 7 is a graph showing etching selectivity of silicon nitride to quartz relative to the flow ratio of nitrogen monoxide gas flow rate and fluorine gas flow rate.

### DETAILED DESCRIPTION OF THE INVENTION

Embodiments of the present invention are described below in detail.

In one embodiment, the present invention relates to a method of cleaning a film-forming apparatus to at least partially remove silicon-based deposits on a constituent member or members of the film-forming apparatus by introducing a cleaning gas into the film-forming apparatus. A gas mixture comprising of a first gas comprising fluorine gas (F₂) and a second gas comprising nitrogen monoxide gas (NO) is used as a cleaning gas.

In one embodiment, the film-forming apparatus in which usual processes to form silicon-based films have been carried out is evacuated firstly.

The film-forming apparatus includes, for example, a CVD reaction chamber. A member for disposing thereon a semiconductor wafer on which the silicon-based film is to be formed, i.e., a boat in the case of a batch type film-forming apparatus or a susceptor in the case of a single wafer type film-forming apparatus, is arranged within the film-forming apparatus. The constituent members of the film-forming apparatus include the CVD reaction chamber and the disposing member of the semiconductor wafer. In general, the wall of the CVD reaction chamber is formed of quartz. On the other hand, the disposing member of the semiconductor wafer is generally formed of quartz, silicon carbide (SiC) or a carbon material having the surface coated with silicon carbide. The film-forming apparatus according to one embodiment of the present invention is used to form a silicon nitride film as the silicon-based thin film. In one embodiment of the present invention, the silicon nitride material deposited on the quartz member or the silicon carbide member is cleaned off. Also, the film-forming apparatus generally comprises pipes for introducing CVD raw material gases into the film-forming apparatus and a pipe for exhausting the gaseous materials from within the film-forming apparatus. These pipes are generally formed of quartz or a stainless steel. Needless to say, the film-forming apparatus also comprises an introducing pipe of fluorine gas and another introducing pipe of nitrogen monoxide gas.

After the evacuation of the film-forming apparatus as noted above, the constituent members of the film-forming apparatus are heated. In the case of a batch type film-forming apparatus, the CVD reaction chamber is heated by a heater arranged around the CVD reaction chamber. At this time, the semiconductor wafer disposing boat arranged within the CVD reaction chamber is also heated. In the case of a single wafer type film-forming apparatus, the susceptor is heated by a heater provided within the susceptor. Note that even in the case of a single wafer type film-forming apparatus, it is possible to arrange a heater around the CVD reaction chamber so as to have the CVD reaction chamber heated by the heater.

After heating the constituent members in this way, a first gas comprising fluorine gas and a second gas comprising nitrogen monoxide gas are introduced into the CVD reaction chamber. An inert diluent gas may also be introduced into the CVD reaction chamber. As the inert diluent gas, a rare gas such as argon gas, or nitrogen gas may be used.

In the cleaning process with the first gas (fluorine gas) and the second gas (nitrogen monoxide gas), the pressure inside the CVD reaction chamber may be maintained at 0.1 Torr to 760 Torr.

In the cleaning operation, the first gas (fluorine gas) and the second gas (nitrogen monoxide gas) are introduced into the CVD reaction chamber at a flow rate ratio of the first gas to the second gas (F₂/NO flow rate ratio) of 0.01 to not higher than 2 in view of the etching selectivity of the silicon nitride deposit to the constituent member of the film-forming apparatus. If the F₂/NO flow rate ratio is 2 or more, the etching selectivity tends to be lowered, and the etching rate of the silicon-based deposit tends to be lowered. In other words, by setting the F₂/NO flow rate ratio R at 0.01≦R<2, the etching rate of the silicon nitride deposit is significantly increased, and the etching selectivity of the silicon nitride deposit to the constituent member of the film-forming apparatus is also improved.

Further, the cleaning operation can be carried out at a temperature of from room temperature to 1,000° C. However, at a high temperature higher than 400° C. or at a low temperature lower than 100° C., the difference in the etching rate between the silicon nitride deposit to be removed and the constituent member of the film-forming apparatus tends to be decreased. Thus, the cleaning operation is carried out at a temperature of 100° C. to 400° C. in one embodiment of the present invention. If the cleaning operation is carried out at a temperature of 100° C. to 400° C., it is possible to obtain the maximum etching selectivity under the second gas/first gas flow rate ratio condition that is set at this stage. In another embodiment, the cleaning operation is carried out at about 200° C. Note that at a temperature exceeding 400° C., the rate of etching of the silicon nitride deposit by the first gas and the second gas is high. Therefore, the cleaning operation can be carried out at a temperature exceeding 400° C. until the silicon nitride deposit is etched to reach a region in the vicinity of the interface with the constituent member of the film-forming apparatus. Then, the cleaning temperature can be lowered stepwise or consecutively to a temperature of 100° C. to 400° C. (preferably about 200° C.), at which a high etching rate selectivity can be obtained, so as to finish the cleaning operation. Note that the cleaning operation conducted to reach the area in the vicinity of the interface between the silicon nitride deposit and the constituent member of the film-forming apparatus can be controlled by the etching time, if the thickness of the silicon nitride deposit and the etching rate of the silicon nitride deposit with the cleaning gas used are measured in advance.

As apparent from the description given above, in order to clean off the silicon nitride deposit at a high rate, while suppressing the damage done to the constituent member of the film-forming apparatus, the cleaning temperature can be set at 100° C. to 400° C. and the F₂/NO flow rate ratio R can be set at 0.01≦R<2.

The second gas (nitrogen monoxide gas) increases the etching rate of the silicon nitride deposit, but does not damage significantly the constituent members of the film-forming apparatus. Thus, the silicon nitride deposit can be selectively removed while suppressing the damage done to the constituent member of the film-forming apparatus.

It should be noted that the fluorine gas (first gas) can be synthesized on site and the synthesized fluorine gas can be introduced into the CVD reaction chamber directly or after stored temporarily. In view of the safety, it is impossible to fill the fluorine gas in a gas cylinder at high pressure. Therefore, it is difficult to carry out the cleaning operation for a long time or clean a plurality of film-forming apparatuses in parallel by utilizing the fluorine gas supplied from the gas cylinder. The difficulty noted above can be overcome by synthesizing the fluorine gas on site. The electrolysis of HF can be employed for synthesizing the fluorine gas. Long-term cleaning and cleaning of a plurality of apparatuses in parallel can be carried out using the fluorine on-site production system by electrolysis of HF. With the fluorine on-site production system, the fluorine supplying amount, which is limited with the volume of the cylinder, does not restrict the cleaning condition. A device for producing fluorine gas by the electrolysis of HF is available on the market.

Needless to say, the cleaning operation is not carried out every time a silicon nitride thin film forming process is carried out. In general, the cleaning operation is carried out after the silicon nitride material has deposited on the constituent members such as the inner wall of the CVD reaction chamber to an unacceptably large thickness by several silicon nitride film forming processes.

Meanwhile, as described above, pipes of the film-forming apparatus may be formed of a stainless steel. It has been found that the life of a stainless steel pipe whose inner surface is coated with nickel, aluminum or alumina is longer, compared to a stainless steel pipe without any coat when it is exposed to fluorine gas nitrogen monoxide gas simultaneously (particularly, an evacuation pipe). The prolonged service life can also be obtained if such a pipe itself is formed of nickel or aluminum. Stainless steel exhibits a particular behavior that its reactivity with a mixture of fluorine gas and nitrogen monoxide gas is higher than that with fluorine gas alone or a mixture of fluorine gas and hydrogen fluoride gas.

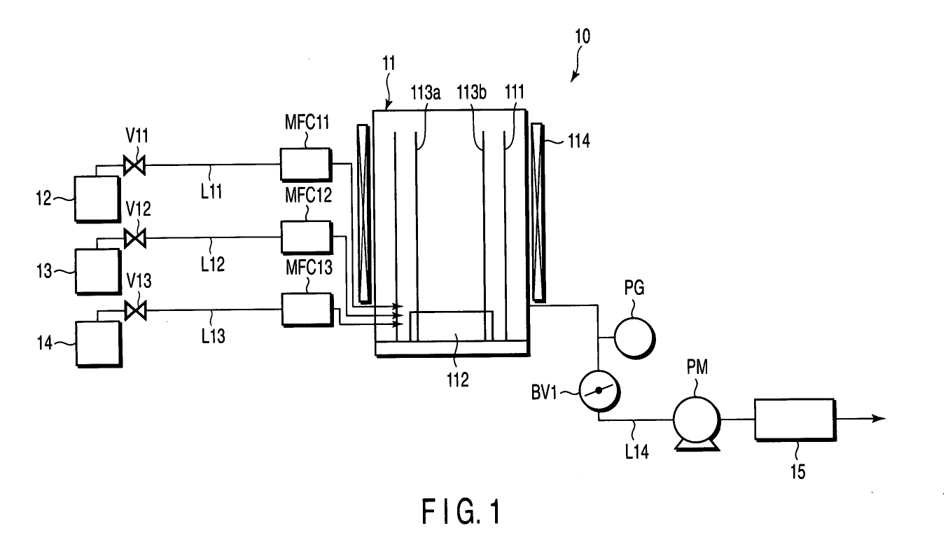

FIG. 1 is a block diagram illustrating a film-forming apparatus equipped with a cleaning system according to an embodiment of the present invention. This film-forming apparatus is of the type that a first gas (fluorine gas) and a second gas (nitrogen monoxide gas) are introduced separately into a CVD reaction chamber.

The film-forming apparatus 10 shown in FIG. 1 comprises a CVD reaction chamber 11, a supply source 12 of a first gas (fluorine gas), a supply source 13 of a second gas (nitrogen monoxide gas), and a supply source 15 of an inert diluent gas supplied where necessary.

The CVD reaction chamber 11 is constituted by a reaction furnace made of, for example, quartz, and a process tube 111 made of, for example, quartz is arranged therein. A semiconductor substrate supporting table 112, and a pair of rods 113a and 113b made of quartz each provided with a plurality of grooves, into which semiconductor substrates (not shown) are inserted to be held, are arranged within the process tube 111. The pair of the quartz rods 113a and 113b collectively constitute a so-called “boat”. A heater 114 surrounds the CVD reaction chamber 11. After formation of the silicon-based thin film, the semiconductor substrate is removed from the boat (rods 113a, 113b). The CVD reaction chamber 11 is heated to a prescribed temperature ture by the heater 114.

The fluorine gas forming the first gas is supplied from the supply source 12 (e.g., a gas cylinder) into the CVD reaction chamber 11 through fluorine gas supply line L11. An on-off valve V11 is mounted on the line L11, and a flow rate controller, for example, a mass flow controller MFC 11, is mounted on the line L11 downstream of the valve V11. The fluorine gas has its flow rate adjusted to a prescribed level by the mass flow controller MFC 11 and is introduced into the CVD reaction chamber 11.

The nitrogen monoxide gas forming the second gas is supplied from the supply source 13 (e.g., a gas cylinder) into the CVD reaction chamber 11 through a second gas supply line L12. An on-off valve V12 is mounted on the supply line L12 and a flow rate controller, e.g., a mass flow controller MFC 12 is mounted on the line L12 downstream of the valve V12. The nitrogen monoxide gas has its flow rate adjusted to a prescribed level by the mass flow controller MFC 12 and is introduced into the CVD reaction chamber 11.

An inert diluent gas is supplied, where necessary, from the supply source 14 (e.g., a gas cylinder) into the CVD reaction chamber 11 through an inert diluent gas supply line L13. An on-off valve V13 is mounted on the supply line L13, and a flow rate controller, e.g., a mass flow controller MFC 13, is mounted on the supply line L13 downstream of the valve V13. The inert diluent gas has its flow rate adjusted to a prescribed level by the mass flow controller MFC 13 and is introduced into the CVD reaction chamber 11.

The outlet port of the CVD reaction chamber 11 is connected to a waste gas treatment unit 15 via a line L 14. The waste gas treatment unit 15 serves to remove the by-products, the unreacted reactants, etc. and the gas cleaned by the waste gas treatment unit 15 is exhausted to the outside of the system. Mounted on the line L14, there are a pressure sensor PG, a pressure controller such as a butterfly valve BV1, and a vacuum pump PM. The pressure inside the CVD reaction chamber 11 is monitored by the pressure sensor PG and is set at a prescribed pressure value by controlling the opening-closing degree of the butterfly valve BV1.

Needless to say, supply systems of CVD raw material gases (not shown) for performing the ordinary CVD reaction (for forming a silicon nitride thin film) is connected to the CVD reaction chamber 11.

With the film-forming apparatus 10 shown in FIG. 1, it is possible to remove the silicon nitride material deposited on, for example, the inner wall of the CVD reaction chamber 11, on the inner and outer surfaces of the process tube 111, and on the quartz rods 113a and 113b by the cleaning method of the present invention after formation of the silicon nitride films on the semiconductor substrates.

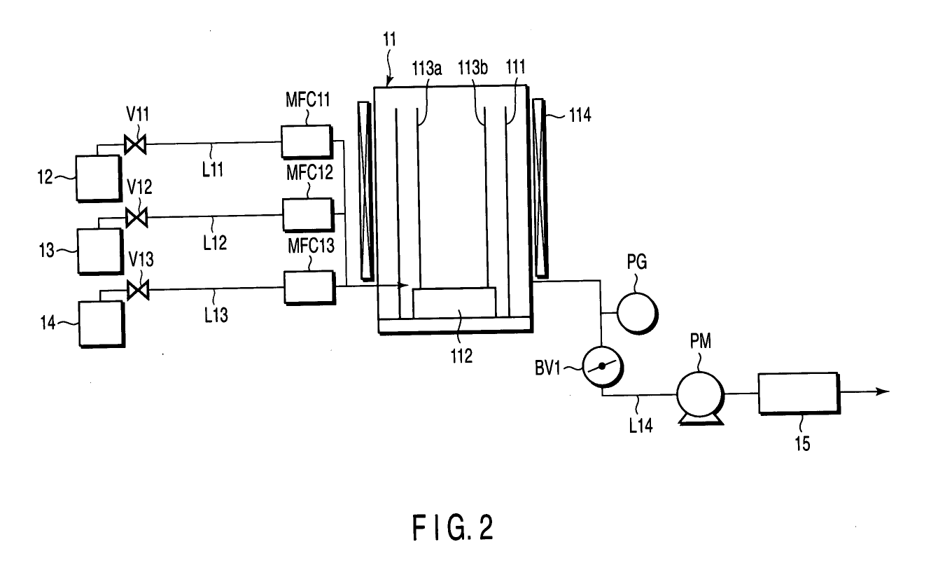

FIG. 2 is a block diagram schematically illustrating a film-forming apparatus of the type that the first gas and the second gas are mixed in advance, and introduced into the CVD reaction chamber 11. The apparatus shown in FIG. 2 has a similar construction to the film-forming apparatus 10 shown in FIG. 1. In FIG. 2, those elements or members which correspond to those in FIG. 1 are denoted by the same reference numerals, and the detailed explanations thereof are omitted for simplicity.

In the film-forming apparatus shown in FIG. 2, the second gas supply line L12 is combined with the first gas supply line Lil upstream of the CVD reaction chamber 11 and the combined line is further combined with the inert diluent gas supply line L13 upstream of the CVD reaction chamber 11. It follows that the first gas, the second gas, and the inert diluent gas, which are mixed in advance, can be introduced into the CVD reaction chamber 11 in the film-forming apparatus shown in FIG. 2.

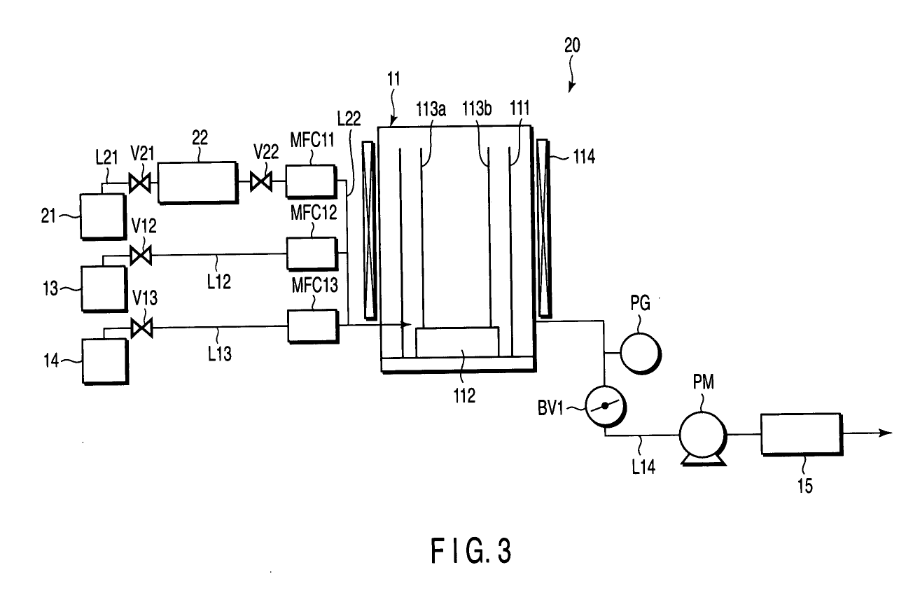

FIG. 3 is a block diagram schematically showing a film-forming apparatus 20, which has the same construction as in FIG. 2, except that the apparatus 20 shown in FIG. 3 comprises a system for producing fluorine gas on site. Those elements of the film-forming apparatus 20 shown in FIG. 3 which correspond to those in FIG. 2 are denoted by the same reference numerals, and the detail explanations thereof are omitted for simplicity.

The film-forming apparatus 20 shown in FIG. 3 is provided with a hydrogen fluoride (HF) gas supply source 21 and fluorine gas producing device 22 for producing fluorine gas by the electrolysis of HF, in place of the fluorine gas supply source 12 in the film-forming apparatus shown in FIG. 2. The HF gas is supplied from the HF gas supply source 21 into the fluorine gas producing device 22 through a HF gas supply line L21. An on-off valve V21 is mounted on the HF gas supply line L21. A buffer tank (not shown) may be provided to temporarily store the produced fluorine gas downstream of the fluorine gas producing device 22. The produced fluorine gas is introduced into the CVD reaction chamber 11 through fluorine gas supply line L22 together with the second gas and, as required, an inert diluent gas. An on-off valve V22 is mounted on the line L22, and a flow rate controller, e.g., a mass flow controller MFC 11, is mounted on the line L22 downstream of the on-off valve V22. The fluorine gas has its flow rate adjusted to a prescribed level by the mass flow controller MFC 11 and is introduced into the CVD reaction chamber 11.

In the system shown in FIG. 3, the fluorine gas is mixed in advance with the second gas and the mixed gas is introduced into the CVD reaction chamber 11. However, it is also possible to introduce the fluorine gas and the second gas separately into the CVD reaction chamber 11 as in the film-forming apparatus 10 shown in FIG. 1.

As described above, each of FIGS. 1 to 3 is directed to a batch type film-forming apparatus. Needless to say, however, the present invention may be applied to a single wafer type film-forming apparatus.

As apparent from the description given above, the present invention makes it possible to remove selectively the silicon nitride material deposited on quartz or silicon carbide.

Some Examples of the present invention will now be described. Needless to say, however, the present invention is not limited to the following Examples.

### EXAMPLE 1

A sample having silicon nitride deposited thereon and a quartz sample were housed in a CVD reaction chamber. Then, fluorine gas and nitrogen monoxide gas were introduced into the CVD reaction chamber to carry out a cleaning operation under the conditions given below:
Fluorine gas flow rate: 500 sccm
Nitrogen monoxide gas flow rate: 200 sccm
Nitrogen gas flow rate: 300 sccm
Pressure inside the CVD reaction chamber: 50 Torr
Cleaning temperature: 200° C.

As a result, the etching rate of the silicon nitride was found to be 3,500 Å/min and the etching rate of the quartz was found to be 220 Å/min. It follows that, in this Example, the etching selectivity of the silicon nitride film to quartz, i.e., a ratio. in the etching rate of the silicon nitride film to the quartz, was about 16, indicating that the silicon nitride film can be removed selectively.

### EXAMPLE 2

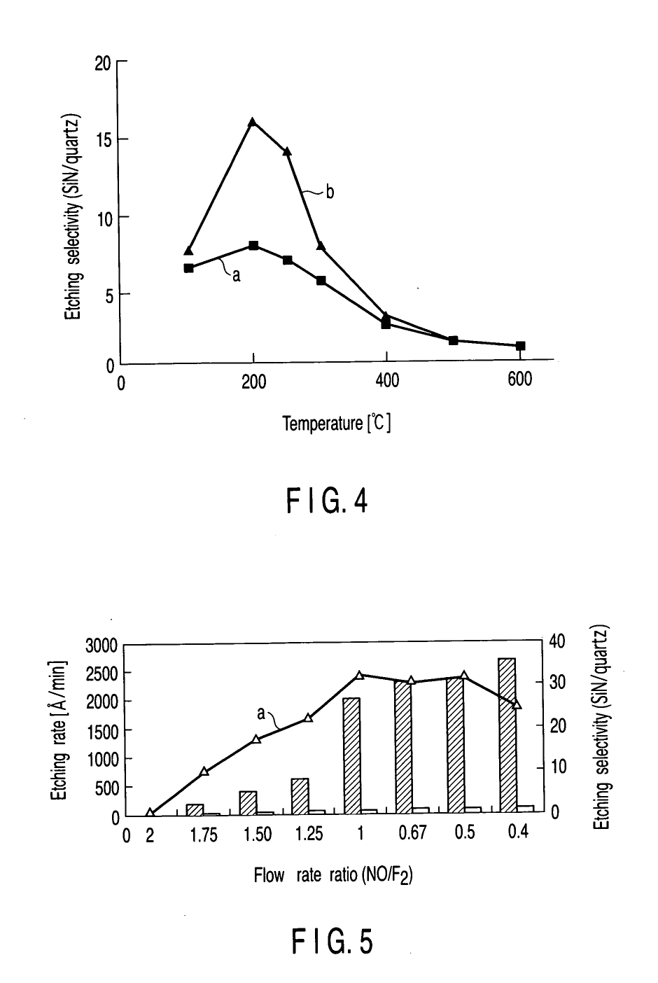

A sample having silicon nitride deposited thereon and a quartz sample were housed in a CVD reaction chamber. Then, a cleaning operation was carried out by introducing fluorine gas and nitrogen monoxide gas into the CVD reaction chamber with the pressure inside the CVD reaction chamber set at 50 Torr and with the flow rates of the fluorine gas and the total gas set at 500 sccm and 1,000 sccm, respectively. In this case, the cleaning temperature was changed within a rage of 100° C. to 600° C. Also, the flow rate of the nitrogen monoxide gas was changed within a range of 100 sccm to 200 sccm. Note that nitrogen gas was introduced into the CVD reaction chamber such that the total gas flow rate was adjusted to 1,000 sccm. The results are shown in FIG. 4. In FIG. 4, curve a shown in relates to the case where the NO/F₂ flow rate ratio was 0.2, and curve b relates to the case where the NO/F₂ flow rate ratio was 0.4.

As apparent from FIG. 4, a maximum etching selectivity (silicon nitride (SiN)/quartz) can be obtained in each of the NO/F₂ flow rate ratios under the cleaning temperature falling within a range of 100° C. to 400° C.

### EXAMPLE 3

A sample having silicon nitride deposited thereon and a quartz sample were housed in a CVD reaction chamber. Then, a cleaning operation was carried out by introducing fluorine gas and nitrogen monoxide gas into the CVD reaction chamber under the conditions that the pressure inside the CVD reaction chamber was set at 50 Torr, the cleaning temperature was set at 200° C., and the nitrogen monoxide gas flow rate and the total gas flow rate were set at 200 sccm and 1,000 sccm, respectively. In this case, the flow rate of the fluorine gas was changed within a range of 100 sccm to 500 sccm. Note that nitrogen gas was introduced into the CVD reaction chamber such that the total gas flow rate was adjusted to 1,000 sccm. The results are shown in FIG. 5. The shaded bar shown in FIG. 5 denotes the etching rate of silicon nitride, and the white bar denotes the etching rate of quartz. Further, curve a denotes the etching selectivity (silicon nitride/quartz).

As apparent from FIG. 5, both the etching rate and the etching selectivity are lowered with increase in the nitrogen monoxide gas/fluorine gas flow rate ratio to approach 2. This clearly indicates that, in order to remove the silicon nitride deposit more rapidly than quartz, the nitrogen monoxide gas/fluorine gas flow rate ratio should be smaller than 2.

### EXAMPLE 4

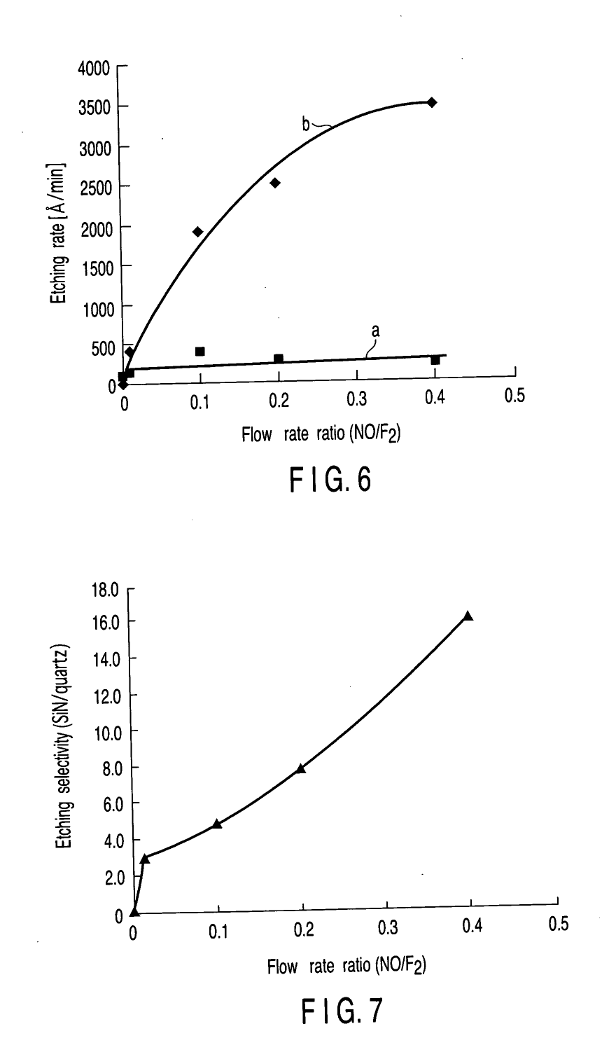

A sample having silicon nitride deposited thereon and a quartz sample were housed in a CVD reaction chamber. Then, fluorine gas and nitrogen monoxide gas were introduced into the CVD reaction chamber with the pressure inside the CVD reaction chamber set at 50 Torr and the cleaning temperature set at 200° C. In this case, the nitrogen monoxide gas flow rate was changed within a range of 0 sccm to 200 sccm while setting the fluorine gas flow rate at 500 sccm. Note that nitrogen gas was introduced into the CVD reaction chamber such that the total gas flow rate was adjusted to 1,000 sccm. The results with respect to the etching rate are shown in FIG. 6, while the results with respect to the etching rate of silicon nitride relative to the selectivity to quartz are shown in FIG. 7. In FIG. 6, curve a relates to quartz, and curve b relates to silicon nitride.

As apparent from FIG. 6, the addition of nitrogen monoxide gas increases the etching rate of silicon nitride with the etching rate of quartz kept constant. Further, the etching rate of silicon nitride tends to be saturated relative to the addition amount of the nitrogen monoxide gas, and the effect can be produced in the case where the nitrogen monoxide gas/fluorine gas flow rate ratio is not smaller than 0.01. Still further, the experimental data given in FIG. 7 support that the etching rate of silicon nitride (denoted by SiN in FIG. 7) is rendered higher than that of quartz in the case where the nitrogen monoxide gas/fluorine gas flow rate ratio is not smaller than 0.01.

### EXAMPLE 5

A sample having silicon nitride deposited thereon, a quartz sample and a silicon carbide sample were housed in the CVD reaction chamber. Then, fluorine gas, a second gas (nitrogen monoxide gas), and nitrogen gas were supplied into the CVD chamber at the flow rate ratio of 50/1/49 with the pressure inside the CVD reaction chamber maintained at 50 Torr. Under this condition, the etching rate of each sample at 300° C. was measured. The results are given below:
Etching rate of silicon carbide: 50 Å/min
Etching rate of quartz: 90 Å/min
Etching rate of silicon nitride: 380 Å/min

For comparison, fluorine gas and nitrogen gas were supplied into the CVD chamber without adding the second gas (nitrogen monoxide gas) with the pressure inside the CVD chamber set at 50 Torr. Under this condition, the etching rate of each sample at 300° C. was measured. The results are given below:
Etching rate of silicon carbide: 6 Å/min
Etching rate of quartz: 14 Å/min
Etching rate of silicon nitride: 0 Å/min

The results clearly indicate that the silicon nitride material deposited on the constituent member formed of silicon carbide or quartz can be removed at a high selectivity by using fluorine gas and nitrogen monoxide gas as the cleaning gas.

### EXAMPLE 6

A stainless steel SS-316L test piece and a nickel test piece were exposed at 200° C. to a mixture of fluorine gas and hydrogen fluoride gas (F₂/HF volume ratio=50/50) or to a mixture of fluorine gas and nitrogen monoxide gas (F₂/NO volume ratio=50/50), at 760 Torr for specified time. The penetration depth of fluorine from the surface of the test piece after the exposure was measured by the Auger electron spectroscopy. The reaction rate (mm/year) of each test piece by each of the gaseous mixtures was calculated from the penetration depth and the exposure time. The results are shown Table 1 below.

TABLE 1

Reaction rate (mm/year)
by the gas mixture

| Gas mixture | SS-316L | Ni |
|---|---|---|
| F₂ + HF | 0.018 | — |
| F₂ + NO | 0.055 | 0.01 |

Table 1 clearly indicates that the stainless steel is more reactive with a mixture of fluorine gas and nitrogen monoxide gas than with a mixture of fluorine gas and hydrogen fluoride gas. On the other hand, nickel is scarcely reactive with a mixture of fluorine gas and nitrogen monoxide gas.

As described above, the cleaning method of the present invention permits removing the silicon nitride deposit rapidly in a short time without doing damage to the constituent members of a film-forming apparatus. Particularly, by setting the cleaning temperature in a range of 100° C. to 400° C., it is possible to obtain a maximum selectivity ratio under the flow rate conditions set in that stage. Also, the second gas/first gas flow rate ratio greatly affects the selectivity ratio and the etching rate. To be more specific, by setting the flow rate ratio in a range of 0.01 to not larger than 2, it is possible to achieve the cleaning of a silicon nitride deposit at a high cleaning rate under a particularly high selectivity ratio.

Additional advantages and modifications will readily occur to those skilled in the art. Therefore, the invention in its broader aspect is not limited to the specific details and representative embodiments shown and described herein. Accordingly, various modifications may be made without departing from the spirit or scope of the general inventive concept as defined by the appended claims and their equivalents.

1. A method of cleaning a film-forming apparatus to remove at least a part of a silicon-based material deposited on a constituent member of the film-forming apparatus after used to form thin films, comprising introducing a first gas comprising fluorine gas and a second gas comprising nitrogen monoxide gas into the film-forming apparatus; and heating the constituent member, wherein the constituent member comprises quartz or silicon carbide, and the silicon-based material comprises silicon nitride.

2. The method according to claim 1, wherein a flow ratio of the first gas introduced into the film-forming apparatus to the second gas is set at 0.01 or more, but smaller than 2.

3. The method according to claim 1, wherein the constituent member is heated to 100° C. to 400° C.

4. The method according to claim 2, wherein the constituent member is heated to 100° C. to 400° C.

5. The method according to claim 1, wherein the first gas is supplied from a hydrogen fluoride electrolysis device equipped to the film-forming apparatus.

6. The method according to claim 1, wherein the film-forming apparatus comprises a stainless steel pipe whose inner surface of the pipe is coated with nickel, aluminum or alumina.

7. The method according to claim 1, wherein the film-forming apparatus comprises a nickel or aluminum pipe.

8. The method according to claim 1, wherein the cleaning is carried out such that after the silicon-based material is removed to reach an area near an interface with the constituent member while heating the constituent member to a temperature higher than 400° C., the temperature is lowered, and the cleaning is finished at a temperature of 100° C. to 400° C.

9. The method according to claim 8, wherein a flow ratio of the first gas introduced into the film-forming apparatus to the second gas is set at 0.01 or more, but smaller than 2.

10. The method according to claim 8, wherein the film-forming apparatus comprises a stainless steel pipe whose inner surface of the pipe is coated with nickel, aluminum or alumina.

11. The method according to claim 8, wherein the film-forming apparatus comprises a nickel or aluminum pipe.

12. A film-forming apparatus including a reaction chamber configured to form a silicon nitride film on a wafer therein, the apparatus comprising a first gas introducing system configured to introduce a first gas comprising fluorine gas into the reaction chamber, and a second gas introducing system configured to introduce a second gas comprising nitrogen monoxide into the reaction chamber.

13. The apparatus according to claim 12, further comprising a hydrogen fluoride electrolysis device which supplies the first gas.

14. The apparatus according to claim 12, wherein the film-forming apparatus comprises a stainless steel pipe whose inner surface of the pipe is coated with nickel, aluminum or alumina.

15. The apparatus according to claim 12, wherein the film-forming apparatus comprises a nickel or aluminum pipe.
